(19) United States
(12) Patent Application Publication
(10) Pub. No.: US 2025/0181988 A1
(43) Pub. Date: Jun. 5, 2025

(54) REINFORCEMENT LEARNING BASED TRANSPILATION OF QUANTUM CIRCUITS

(71) Applicant: International Business Machines Corporation, Armonk, NY (US)

(72) Inventors: David Kremer Garcia, White Plains, NY (US); Juan Cruz Benito, Salamanca (ES); Victor Villar Pascual, Scarsdale, NY (US); Hanhee Paik, Danbury, CT (US); Ismael Faro Sertage, CHAPPAQUA, NY (US); Ivan Duran Martinez, Elmsford, NY (US); Francisco Jose Martin Fernandez, Ridgefield, CT (US); Alexandra Rivero García, La Orotava (ES)

(21) Appl. No.: 18/526,120

(22) Filed: Dec. 1, 2023

(51) Int. Cl. G06N 20/10

(52) U.S. Cl. CPC G06N 20/10

(57) ABSTRACT

Systems and techniques that facilitate quantum circuit transpiling are provided. For example, one or more embodiments described herein can comprise a system, which can comprise a memory that can store computer executable components. The system can also comprise a processor, operably coupled to the memory that can execute the computer executable components stored in memory. The computer executable components can comprise a receiver component that receives an input quantum circuit representation and one or more quantum circuit constraints, a machine learning component that generates a transpiled quantum circuit representation based on the one or more quantum circuit constraints and the input quantum circuit representation.

### BACKGROUND

The subject disclosure relates to quantum circuit transpiling, and more specifically, to reinforcement learning based transpilation of quantum circuits.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that facilitate quantum circuit transpiling are provided.

According to an embodiment, a system can comprise a processor that executes computer executable components stored in memory. The computer executable components can comprise a receiver component that receives an input quantum circuit representation and one or more quantum circuit constraints, and a machine learning component that generates a transpiled quantum circuit representation based on the one or more quantum circuit constraints and the input quantum circuit representation.

According to another embodiment, a computer-implemented method can comprise, receiving, by a system operatively coupled to a processor, an input quantum circuit representation and one or more quantum circuit constraints, and generating, by the system, using a machine learning model, a transpiled quantum circuit representation based on the one or more quantum circuit constraints and the input quantum circuit representation.

According to another embodiment, a computer program product comprising a computer readable storage medium having program instructions embodied therewith, the program instructions executable by a processor to cause the processor to receive an input quantum circuit representation and one or more quantum circuit constraints, and generate a transpiled quantum circuit representation based on the one or more quantum circuit constraints and the input quantum circuit representation.

### DESCRIPTION OF THE DRAWINGS

FIG. 1 illustrates a block diagram of example, non-limiting systems that can facilitate quantum circuit transpiling, in accordance with one or more embodiments described herein.

FIG. 2 illustrates a block diagram of example, non-limiting systems that can facilitate quantum circuit transpiling, in accordance with one or more embodiments described herein.

FIG. 3 illustrates a block diagram of a cloud inference and training system, in accordance with one or more embodiments described herein.

FIG. 4 illustrates a block diagram of a local inference system, in accordance with one or more embodiments described herein.

FIG. 5 includes a flow diagram of an example, non-limiting, computer implemented method that facilitates transpiling of quantum circuits, in accordance with one or more embodiments described herein.

FIG. 6 includes a flow diagram of an example, non-limiting, computer implemented method that facilitates transpiling of quantum circuits, in accordance with one or more embodiments described herein.

FIG. 7 depicts an output of transpiling a quantum circuit using the reinforcement learning method described herein, in accordance with one or more embodiments described herein.

FIG. 8 illustrates an example, non-limiting environment for the execution of at least some of the computer code in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

As referenced herein, an “entity” can comprise a client, a user, a computing device, a software application, an agent, a machine learning (ML) model, an artificial intelligence (AI) model, and/or another entity.

Quantum circuit transpiling can refer to the process of rewriting a given input quantum circuit to match the topology of a specific target quantum device, and/or to optimize the circuit for execution on present day noisy quantum systems. Matching the topology of the specific target quantum device by transpilation can refer to the process of rewriting the given input quantum circuit to match qubit connectivity constraints of different implementation environments. In quantum computing, optimization of quantum circuits can generally refer to circuits with fewer gates, fewer circuit layers, decreased circuit length, decreased circuit noise, etc.), with this optimization generally being preferred because it can improve the performance of execution of a quantum circuit on particular quantum hardware that may have performance limitations based on qubit layout, and the number of qubits. The process of optimization for a particular quantum computer can further include, but is not limited to, circuits that can directly leverage local circuit optimizations, e.g. two CNOT cancellation, swap absorption by a 2 qubit unitary, etc., circuits that can be optimized for execution on noisy quantum systems.

An example of a transpiling process described herein includes transpiling by qubit routing, e.g., the rearrangement and manipulation of qubits within an input quantum circuit to generate a transpiled quantum circuit that can accommodate the physical constraints of a target quantum computer. Different physical constraints can include, but are not limited to, a topology of a specific quantum device, limits on which qubit pairs can be used to apply two-qubit gates (e.g., CNOTs, SWAPS, etc).

In view of the problems discussed above, in relation to quantum circuit transpiling, the present disclosure can be implemented to produce a solution to one or more of these problems by receiving an input quantum circuit representation and one or more quantum circuit constraints, and generating, by the system, using a machine learning model, a transpiled quantum circuit representation based on the one or more quantum circuit constraints and the input quantum circuit representation. By utilizing a machine learning model, optimized circuit transpiling can be performed rapidly, allowing for a desired performance result in a much shorter period of time.

In additional or alternative embodiments, generating the transpiled quantum circuit representation can include, selecting one or more gate options from a plurality of gate options, assigning a penalty term to the selected one or more gate options based on the one or more quantum circuit constraints, and selecting one or more additional gate options from the plurality of gate options based on the penalty term. In additional or alternative embodiments, the plurality of gate options include a SWAP option to add a SWAP layer to the transpiled quantum circuit representation during generation of the transpiled quantum circuit representation. In additional or alternative embodiments, selection the one or more additional gate options can be further based on gates of the input quantum circuit representation remaining to be transpiled.

In additional or alternative embodiments, the defined preference can include one or more performance characteristics of the target quantum computer, including performance gates of the target quantum computer, a coupling map of qubits of the target quantum computer, a gate canceling optimization of the target quantum computer, and a gate merging optimization of the target quantum computer. In additional or alternative embodiments, the defined preference can include one or more characteristics of a configuration of the target quantum computer, can include, an estimated resonance frequency of qubits of the target quantum computer, an estimated frequency of state measurement pulses of the target quantum computer, a buffer time required between successive operations on the target quantum computer, a pulse library of the target quantum computer, a set of available quantum operations of the target quantum computer, an algorithm that processes qubit measurements to produce usable data from the target quantum computer, a discriminator of the target quantum computer, and a data structure that stores results of quantum operations of the target quantum computer. In additional or alternative embodiments, defined preference can include at least one of a number of controlled not (CNOT) gates, a number of circuit layers with CNOT gates, length of the quantum circuit, estimated total gate noise of the quantum circuit.

In additional or alternative embodiments, the one or more quantum circuit constraints can include descriptive characteristics of the target quantum computer can include one or more of, a number of qubits included in the target quantum computer, basic gates of the target quantum computer, a time step parameter for gate operations of the target quantum computer, measurement levels the target quantum computer, and a measurement map of qubits of the target quantum computer.

In additional or alternative embodiments, generating the transpiled quantum circuit representation can include, generating a plurality of candidate quantum circuit representations based on the input quantum circuit representation, and selecting the transpiled quantum circuit representation from the plurality of candidate quantum circuit representations based on the defined preference. Additional or alternative embodiments can include a performance component that can identify a performance metric representing a difference between the input quantum circuit representation and the transpiled quantum circuit representation, and a training component that retrains the machine learning component based on maximizing the performance metric and the transpiled quantum circuit representation.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

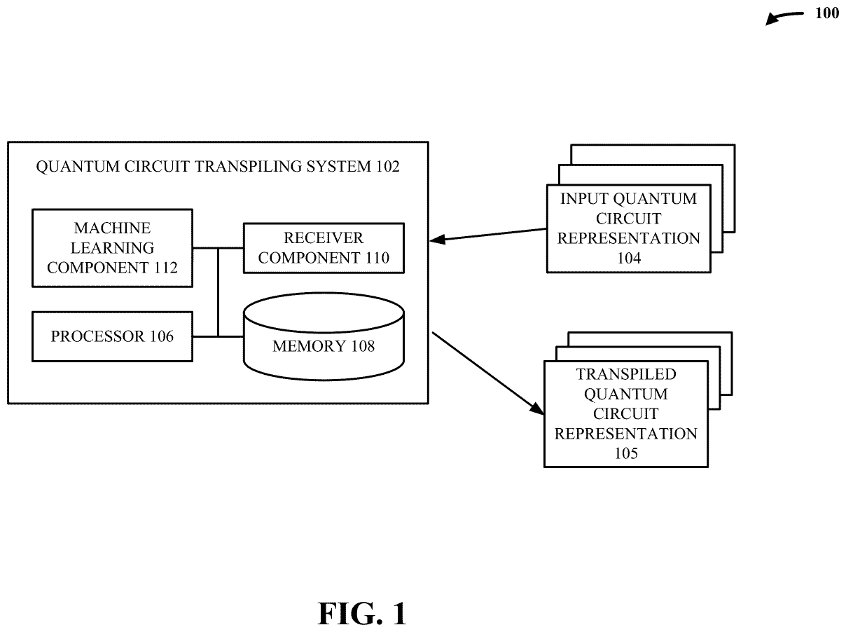

FIG. 1 illustrates block diagram of an example, non-limiting system 100 that can facilitate transpiling of quantum circuits in accordance with one or more embodiments described herein. Aspects of systems (e.g., quantum circuit transpiling system 102 and the like), apparatuses or processes in various embodiments of the present invention, can constitute one or more machine-executable components embodied within one or more machines (e.g., embodied in one or more computer readable mediums (or media) associated with one or more machines). Such components, when executed by the one or more machines (e.g., computers, computing devices, virtual machines, etc.), can cause the machines to perform the operations described. Quantum circuit transpiling system 102 can comprise receiver component 110, machine learning component 112, processor 106 and memory 108.

In various embodiments, quantum circuit transpiling system 102 can comprise a processor 106 (e.g., a computer processing unit, microprocessor) and a computer-readable memory 108 that is operably connected to the processor 106. The memory 108 can store computer-executable instructions which, upon execution by the processor, can cause the processor 106 and/or other components of the quantum circuit transpiling system 102 (e.g., receiver component 110 and/or machine learning component 112) to perform one or more acts. In various embodiments, the memory 108 can store computer-executable components (e.g., receiver component 110 and/or machine learning component 112), the processor 106 can execute the computer-executable components.

According to some embodiments, the machine learning component 112 can employ automated learning and reasoning procedures (e.g., the use of explicitly and/or implicitly trained statistical classifiers) in connection with performing inference and/or probabilistic determinations and/or statistical-based determinations in accordance with one or more aspects described herein.

For example, the machine learning component 112 can employ principles of probabilistic and decision theoretic inference to determine one or more responses based on information retained in a knowledge source database. In various embodiments, the machine learning component 112 can employ a knowledge source database comprising quantum circuits previously transpiled by machine learning component 112. Additionally or alternatively, machine learning component 112 can rely on predictive models constructed using machine learning and/or automated learning procedures. Logic-centric inference can also be employed separately or in conjunction with probabilistic methods. For example, decision tree learning can be utilized to map observations about data retained in a knowledge source database to derive a conclusion as to a response to a question.

As used herein, the term “inference” refers generally to the process of reasoning about or inferring states of the system, a component, a module, the environment, and/or assessments from one or more observations captured through events, reports, data, and/or through other forms of communication. Inference can be employed to identify a specific context or action, or can generate a probability distribution over states, for example. The inference can be probabilistic. For example, computation of a probability distribution over states of interest can be based on a consideration of data and/or events. The inference can also refer to techniques employed for composing higher-level events from one or more events and/or data. Such inference can result in the construction of new events and/or actions from one or more observed events and/or stored event data, whether or not the events are correlated in close temporal proximity, and whether the events and/or data come from one or several events and/or data sources. Various classification schemes and/or systems (e.g., support vector machines, neural networks, logic-centric production systems, Bayesian belief networks, fuzzy logic, data fusion engines, and so on) can be employed in connection with performing automatic and/or inferred action in connection with the disclosed aspects. Furthermore, the inference processes can be based on stochastic or deterministic methods, such as random sampling, Monte Carlo Tree Search, and so on.

The various aspects (e.g., in connection with automatic transpiling of input quantum circuits) can employ various artificial intelligence-based schemes for carrying out various aspects thereof. For example, a process for evaluating one or more SWAP options can be utilized to generate one or more transpiled quantum circuits, without interaction from the target entity, which can be enabled through an automatic classifier system and process.

A classifier is a function that maps an input attribute vector, x=(x1, x2, x3, x4, xn), to a confidence that the input belongs to a class. In other words, f(x)=confidence(class). Such classification can employ a probabilistic and/or statistical-based analysis (e.g., factoring into the analysis utilities and costs) to prognose or infer an action that should be employed to make a determination. The determination can include, but is not limited to, whether to select a gate SWAP options from a plurality of gate options, and/or whether to select a generated quantum circuit from a plurality of generated quantum circuits.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that can be similar, but not necessarily identical to training data. Other directed and undirected model classification approaches (e.g., naïve Bayes, Bayesian networks, decision trees, neural networks, fuzzy logic models, and probabilistic classification models) providing different patterns of independence can be employed. Classification as used herein, can be inclusive of statistical regression that is utilized to develop models of priority.

One or more aspects can employ classifiers that are explicitly trained (e.g., through a generic training data) as well as classifiers that are implicitly trained (e.g., by observing and recording target entity behavior, by receiving extrinsic information, and so on). For example, SVM's can be configured through a learning phase or a training phase within a classifier constructor and feature selection module. Thus, a classifier(s) can be used to automatically learn and perform a number of functions, including but not limited to, generating, a transpiled quantum circuit representation based on one or more quantum circuit constraints and an input quantum circuit representation. Furthermore, one or more aspects can employ machine learning models that are trained utilizing reinforcement learning. For example, penalty/reward scores can be assigned for various gates selected by the machine learning component 112 based on one or more circuit constraints, performance metrics, restrictions, conditions, and/or defined entity preferences. Accordingly, the machine learning component 112 can learn via selecting gate options with lower penalties and/or higher rewards in order to reduce an overall penalty score and/or increase an overall reward score.

In one or more embodiments, receiver component 110 can receive a quantum circuit representation, and one or more quantum circuit constraints. In one or more embodiments, the input quantum circuit representation comprises a quantum circuit represented as a series of gates. For example, the input quantum circuit representation can be a standard circuit representation such as QASM, QPY, or other similar formats.

One or more embodiments can transpile the input quantum circuit representation so as to match qubit connectivity constraints of different implementation environments, e.g., for running a given quantum circuit on a target quantum computer, the circuit may need to be adapted to satisfy different connectivity constraints described herein. Constraints received by receiver component 110 can include conditions that serve as limits for the generation of quantum circuits. For example, the circuit restrictions can comprise restrictions such as capabilities of a quantum computer or quantum simulator, the number of number of qubits within a quantum computer or quantum simulator, quantum device topology, gate times, error rates, connectivity restrictions, time allowed for circuit transpiling, and/or other restrictions. In some embodiments, the circuit constraints can also specify a specific machine learning model and/or type of machine learning model. For example, the constraints can specify whether a stochastic or deterministic method is utilized. Accordingly, the circuit constraints can serve as hard restraints for quantum circuit transpiling (e.g., conditions that must be met or achieved).

In various embodiments, the receiver component 110 can also receive defined preferences from an entity. The defined preferences can include preferences such as a number of Controlled Not (CNOT) gates, a number of circuit layers with CNOT gates, circuit length, circuit noise, a number of quantum circuits to generate, and/or other defined entity preferences. As described below in greater detail, the defined preference metrics can be utilized as soft constraints (e.g., conditions that can be violated, but are reward for complying with).

In one or more embodiments, machine learning component 112 can generate one or more transpiled quantum circuit representations based on the one or more constraints and the input quantum circuit representation. For example, the input quantum circuit representation, the one or more circuit constraints, defined preferences, and/or the one or more defined performance metrics can be utilized by a machine learning model to generate one or more transpiled quantum circuits. In an embodiment, the machine learning component 112 can comprise multiple machine learning models. For example, the machine learning component 112 can comprise multiple machine learning models of the same type, to enable parallel or simultaneous generation of multiple quantum circuit representations. In another example, the machine learning component 112 can comprise different types of machine learning models. For example, different machine learning models can be optimized for different quantum device restrictions, device topologies and/or specific quantum hardware or specific quantum simulators. Accordingly, machine learning component 112 can select an appropriate machine learning model based on the one or more circuit restrictions and/or defined entity preferences.

Once a machine learning model has been selected by machine learning component 112, the machine learning model can use the input quantum circuit representation, one or more circuit constraints, and/or one or more defined entity preferences as input for an inference process. For example, the selected machine learning model can perform an inference process based on reinforcement learning, which is an area of machine learning concerned with how intelligent agents ought to take actions in an environment to maximize the notion of cumulative reward, e.g., where actions taken during the inference process receive a penalty score based on the action.

In an embodiment, the penalty score can comprise a negative value for a negative action, a zero for a neutral action, or a positive score for a positive action. A positive score can alternatively be referred to as a reward or reward score. Once the inference process is complete, the cumulative penalty score of all the actions can be utilized to represent how effective the inference process was. For example, a higher score can represent a good outcome, while a comparatively lower score can represent a worse outcome.

In an embodiment, the machine learning component 112 can utilize a reinforcement learning model to implement a constraint that is a connectivity constraint associated with a number of SWAP layers in the transpiled quantum circuit, and a penalty with a large negative term can be awarded in order to prevent the machine learning model from selecting a comparatively large number of SWAP gates, while a comparatively lower number of SWAP gates may be awarded a less negative penalty score or a neutral score. Thus, based on the quantum circuit representation and the SWAP connectivity constraints, the machine learning component 112 can, for each gate in the transpiled circuit representation, perform a step-by-step transpilation process by introducing SWAP layers at each step until the current gate satisfies the constraints. The selection of which SWAPS to introduce at each step can be made by the the machine learning component 112 based on observing a representation of the current circuit and remaining gates to transpile.

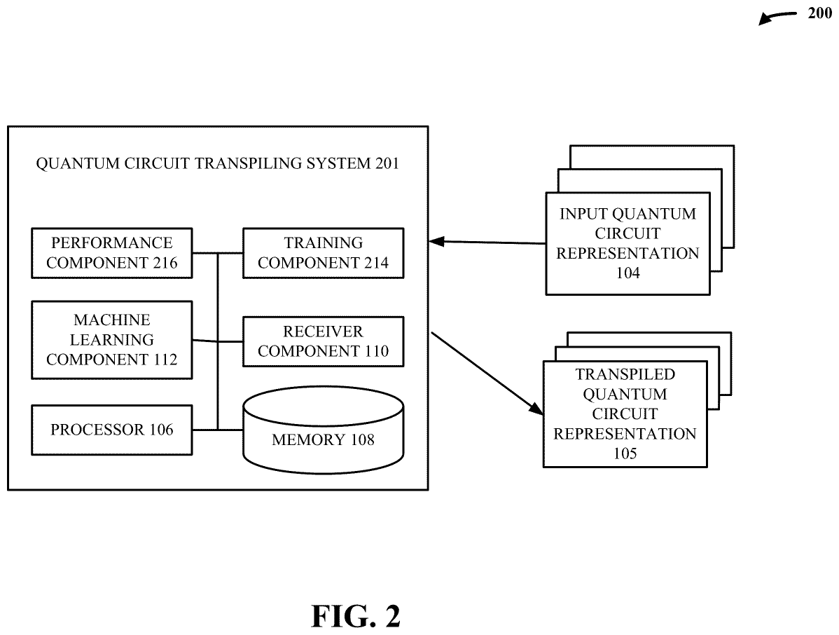

In another embodiment, penalty scores can be assigned based on the complexity of the gate or the number of qubits the gate acts on. For example, a gate that acts on multiple qubits can be assigned a larger negative penalty, while a gate that acts on a single qubit can be assigned a relatively smaller negative penalty. Based on the penalty score, the machine learning model can select an additional gate option from the plurality of gate options. For example, after selecting a gate option with a large negative value penalty score, the machine learning model can prioritize an additional gate option with a less negative score. In another example, if the machine learning model selects a gate option that causes the transpiled quantum circuit representation to match the quantum circuit, then a large positive reward term can be assigned. Once the transpiled quantum circuit representation has been generated, a cumulative penalty score can be determined based on a summation of the penalty scores of the gates that were selected. As described in greater detail below in regard to FIG. 2, the cumulative penalty score can be utilized to retrain the machine learning model.

In an embodiment, machine learning component 112 can generate multiple transpiled quantum circuit representations. For example, the selected machine learning model of machine learning component 112 can generate a plurality of transpiled quantum circuit representations through multiple iterations. In another example, multiple machine learning model of machine learning component 112 can operate in parallel or simultaneously to produce the plurality of possible transpiled quantum circuit representations. Once the plurality of possible transpiled quantum circuit representations is generated, then the machine learning component 112 can output the multiple transpiled quantum circuit representations to an entity for the entity to select a preferred transpiled quantum circuit representation. In another example, the machine learning component 112 can select a transpiled quantum circuit representation from the plurality of transpiled quantum circuit representations based on the defined preference metrics.

For example, if the defined preference metrics comprise a preference for a limited number of CNOT gates, or a limited number of gate layers, then the machine learning component 112 can select the transpiled quantum circuit representation with the fewest CNOT gates or the fewest gate layers from the plurality of possible transpiled quantum circuit representations. In another embodiment, the machine learning component 112 can select multiple transpiled quantum circuit representations from the plurality of possible transpiled quantum circuit representations. For example, based on entity input to select N number of circuits, the machine learning component 112 can select N circuits from the plurality of possible transpiled quantum circuit representations based on the defined preference metrics. Alternatively, the circuit with the highest cumulative score can be selected and output. It should be appreciated that while examples of defined preference metrics are provided herein, use of any metric related to the layout of a circuit and/or circuit performance is envisioned. In one or more embodiments, the transpiled quantum circuit representation can have a phase graph that is identical to the phase graph of the quantum circuit representation.

In an embodiment, the number of circuits within the plurality of possible transpiled quantum circuit representations can be based on connectivity constraints. For example, the circuit restrictions may comprise instructions to generate N circuits, wherein the machine learning component 112 will iterate N times to produce N circuits. In another example, the circuit restrictions may comprise a time limit, wherein the machine learning component 112 will continuously generate possible transpiled quantum circuit representations until the time limit is reached. Once a transpiled quantum circuit representation has been generated and selected, the transpiled quantum circuit can then be sent to a quantum computer or to a quantum simulator to be run.

FIG. 2 illustrates block diagram of an example, non-limiting system 200 that can facilitate transpiling of quantum circuits in accordance with one or more embodiments described herein. Repetitive description of like elements employed in other embodiments described herein is omitted for sake of brevity.

As shown, quantum circuit transpiling system 201 further comprises a performance component 216, and a training component 214. In an embodiment, training component 214 can perform a training process to initialize the machine learning models of machine learning component 112 utilizing reinforcement learning. Reinforcement learning operates based on assigning penalty or reward scores to actions taken by a machine learning model, with the machine learning model being trained to maximize a reward or positive score and minimize a penalty or negative score. Once an output has been scored, the machine learning model can be trained utilizing high scoring outputs as examples of correct outputs and low scoring outputs as examples of incorrect outputs. Therefore, the machine learning model can be trained to generate outputs that attempt to increase or maximize a reward score. Accordingly, during a training process, a machine learning model can be trained to generate outputs that have scored highly and avoid outputs that would score poorly. In this manner, reinforcement learning can be utilized to balance the issue of exploration and exploration cost. As described above in relation to FIG. 1, machine learning component 112 can assign cumulative penalty scores to generated transpiled quantum circuit representations based on penalty scores for individual gates selected during the transpiling process. Accordingly, training component 214 can train one or more machine learning models of machine learning component 112 by providing machine learning component 112 with quantum circuit representations to generate transpiled quantum circuit representations from, and then updating the training of the relevant machine learning model based on cumulative penalty score of the generated transpiled quantum circuit representation.

In an embodiment, performance component 216 can determine a performance metric between the input quantum circuit representation and the transpiled quantum circuit representation. For example, once a transpiled quantum circuit representation has been generated, performance component 216 can run both the input quantum circuit and the transpiled quantum circuit on a quantum computer comprising physical qubits or on a quantum simulator to compare a performance metric between the two circuits. The performance metric can comprise any metric related to quantum circuits, such as but not limited to, gate connectivity, gate noise, error rates, or other performance related metrics. If the transpiled quantum circuit representation has improved performance metrics compared to the original input quantum circuit representation, then the transpiled quantum circuit representation can be sent to the training component 214 and used as a positive example in order to retrain the machine learning models of the machine learning component 112, thereby improving the performance metric of transpiled quantum circuit representations generated in the future. Alternatively, if the transpiled quantum circuit representation has decreased performance metrics compared to the initial quantum circuit representation, then the transpiled quantum circuit representation can be sent to the training component 214 and used as a negative example in order to retrain the machine learning models of the machine learning component 112.

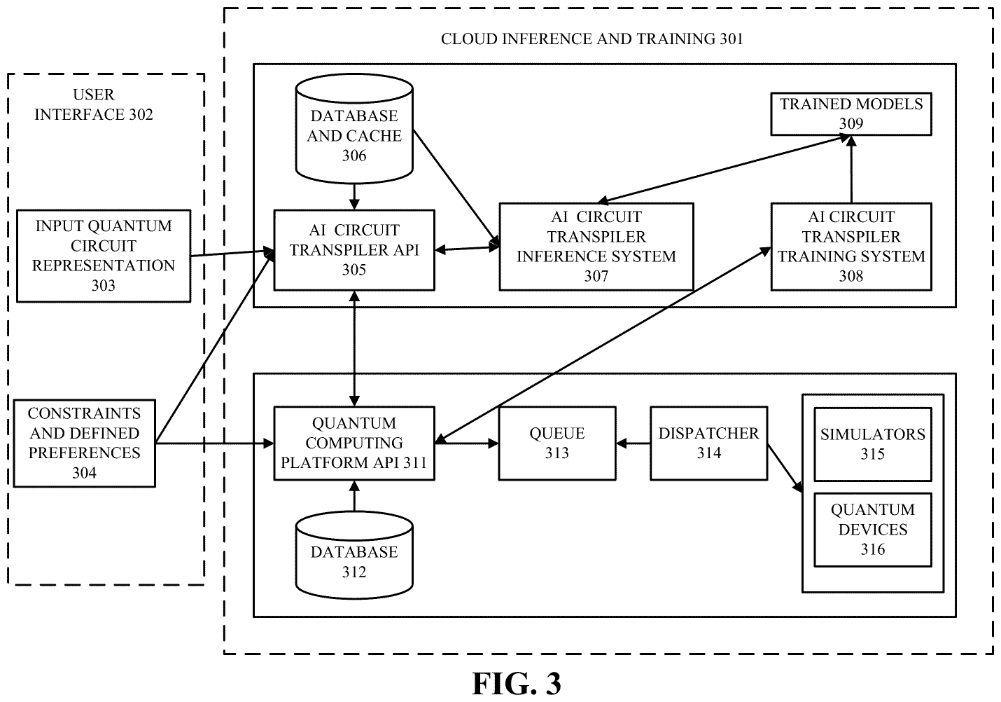

FIG. 3 illustrates a block diagram of cloud inference and training system 301 in accordance with one or more embodiments described herein. Repetitive description of like elements employed in other embodiments described herein is omitted for sake of brevity.

As shown, an entity can utilize user interface 302 to input quantum circuit representation 303, circuit constraints and defined preferences 304. The input quantum circuit representation 303 and the constraints and defined preferences 304 can be sent to the AI circuit transpiler application programing interface (API) 305 and the constraints and defined preferences 304 can additionally be sent to quantum computing platform API 311. As described above in reference to machine learning component 112 of FIGS. 1 and 2, AI circuit transpiler inference system 307 can select one or more machine learning models of trained models 309 and utilize the one or more machine learning models to generate a transpiled quantum circuit representation and transpiled quantum circuit based on the input quantum circuit representation 303 and the constraints and defined preferences 304. Furthermore, the one or more machine learning models can be selected based on the input quantum circuit representation 303, and/or by being specified. For example, in some embodiments different machine learning models or different versions of a machine learning model can be used for different target quantum computer implementations, and/or different performance goals.

The transpiled quantum circuit can then be sent to Quantum computing platform API 311 via AI circuit transpiler API 305. Quantum computing platform API 311 can then send the transpiled quantum circuit to queue 313 and to dispatcher 314, which can run the transpiled quantum circuit on either quantum devices 316 or on quantum simulator 315. Based on the performance of the transpiled quantum circuit when run, quantum computing platform API 311 can send the transpiled quantum circuit to AI circuit transpiler training system 308 in order to utilize the transpiled quantum circuit to retrain one or more models of the trained models 309.

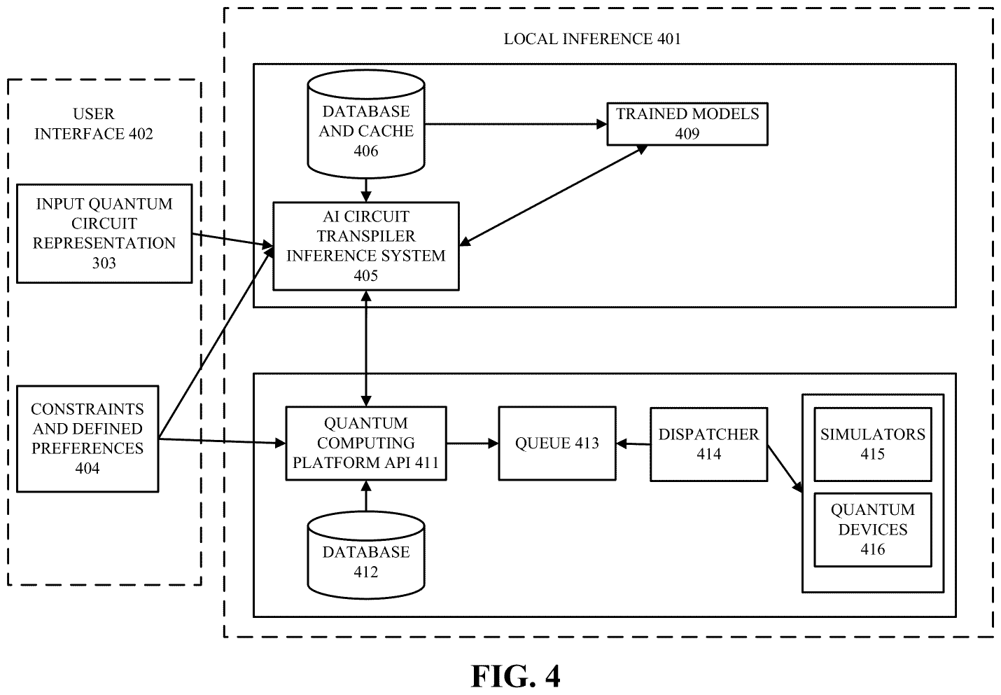

FIG. 4 illustrates a block diagram of a local inference system 401 in accordance with one or more embodiments described herein. Repetitive description of like elements employed in other embodiments described herein is omitted for sake of brevity.

As shown, an entity can utilize user interface 402 to input quantum circuit representation 403 and circuit constraints and defined preferences 404. The input quantum circuit representation 403 and the constraints and defined preferences 404 can be sent to the AI circuit transpiler inference system 405 and the constraints and defined preferences 404 can additionally be sent to quantum computing platform API 411. As described above in relation to machine learning component 112 of FIGS. 1 and 2, AI circuit transpiler inference system 405 can select one or more machine learning models of trained models 409 and utilize the one or more machine learning models to generate a transpiled quantum circuit representation and transpiled quantum circuit based on the input quantum circuit representation 403 and the constraints and defined preferences 404. Furthermore, the one or more machine learning models can be selected based on the input quantum circuit representation 303. The transpiled quantum circuit can then be sent to Quantum computing platform API 411. Quantum computing platform API 411 can then send the transpiled quantum circuit to queue 413 and to dispatcher 414, which can run the transpiled quantum circuit on either quantum devices 416 or on quantum simulator 415.

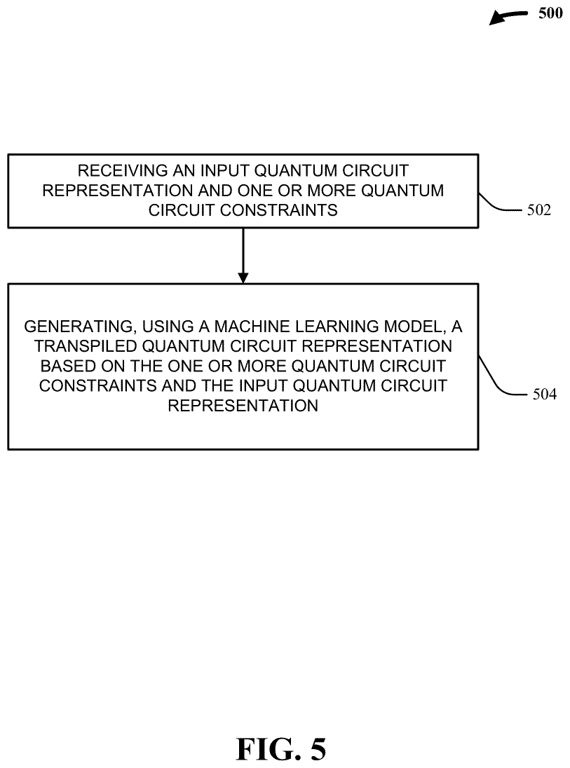

FIG. 5 illustrates a flow diagram of an example, non-limiting, computer implemented method 500 that facilitates transpiling of quantum circuits in accordance with one or more embodiments described herein. Repetitive description of like elements employed in other embodiments described herein is omitted for sake of brevity.

At 502, method 500 can comprise receiving, by a system (e.g., quantum circuit transpiling system 102 and/or receiver component 110) operatively coupled to a processor (e.g., processor 106), an input quantum circuit representation and one or more quantum circuit constraints. As described in greater detail above in reference to FIGS. 1 and 2, the one or more constraints can comprise the topology of a target quantum computer, and the quantum circuit representation can comprise a series of gates that define a quantum circuit.

At 504, method 500 can comprise generating, by the system (e.g., machine learning component 112), using a machine learning model, a transpiled quantum circuit representation based on the one or more quantum circuit constraints and the input quantum circuit representation.

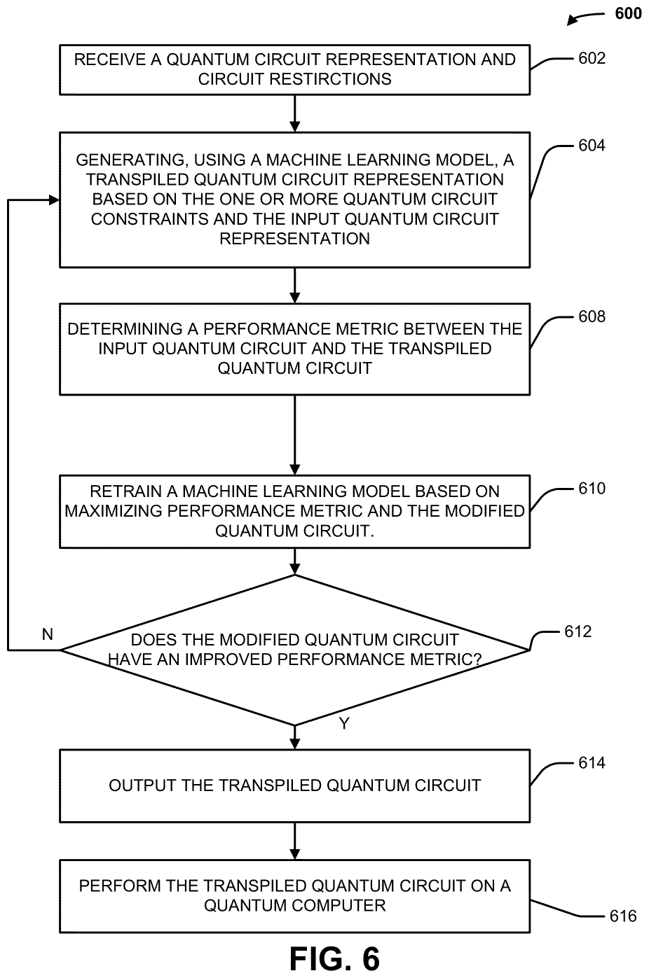

FIG. 6 illustrates a flow diagram of an example, non-limiting, computer implemented method 600 that facilitates transpiling of quantum circuits in accordance with one or more embodiments described herein. Repetitive description of like elements employed in other embodiments described herein is omitted for sake of brevity.

At 602, method 600 can comprise receiving, by a system (e.g., quantum circuit transpiling system 102 and/or receiver component 110) operatively coupled to a processor (e.g., processor 106), an input quantum circuit representation and one or more quantum circuit constraints. At 604, method 600 can comprise generating, by the system (e.g., machine learning component 112), using a machine learning model, a transpiled quantum circuit representation based on the one or more quantum circuit constraints and the input quantum circuit representation. As described above in greater detail in reference to FIGS. 1 and 2, the transpiled quantum circuit representation can have a phase graph that is identical to the phase graph of the quantum circuit representation.

At 608, method 600 can include determining, by the system (e.g., performance component 216), a performance metric between the input quantum circuit and the transpiled quantum circuit. For example, as described above in reference to FIG. 2, the performance component 216 can run both the quantum circuit representation and the transpiled quantum circuit representation on either quantum hardware or a quantum simulator and compare the performance between the representations

At 610, method 600 can comprise retraining, by the system, (e.g., training component 214), the machine learning model based on maximizing the performance metric and the transpiled quantum circuit representation. For example, as described above in relation to FIG. 2, if the transpiled quantum circuit representation has an improved performance metric when compared to the original quantum circuit representation, then the transpiled quantum circuit representation can be utilized as a positive training sample for retraining, otherwise, the transpiled quantum circuit representation can be utilized as a negative sample for retraining.

At 612, if the transpiled quantum circuit has an improved performance metric, method 600 can proceed to step 614 and output the transpiled quantum circuit representation to an entity. If the transpiled quantum circuit does not have an improved performance metric, method 600 can return to step 604 to generate a new transpiled quantum circuit representation. In some embodiments, the transpiled quantum circuit representation can be stored in a database for future use and/or lookup.

At 614, method 600 can comprise performing, by the system (e.g., quantum simulators 315 and/or quantum devices 316) the transpiled quantum circuit on a quantum computer. For example, the transpiled circuit can by performed on quantum simulators or quantum hardware. In one or more embodiments, the amount of time to produce and execute the quantum circuits is decreased as transpilation time is decreased, while accuracy of the generated circuits can be maintained or improved, thereby providing a practical improvement in performance of systems executing quantum circuits and quantum computing.

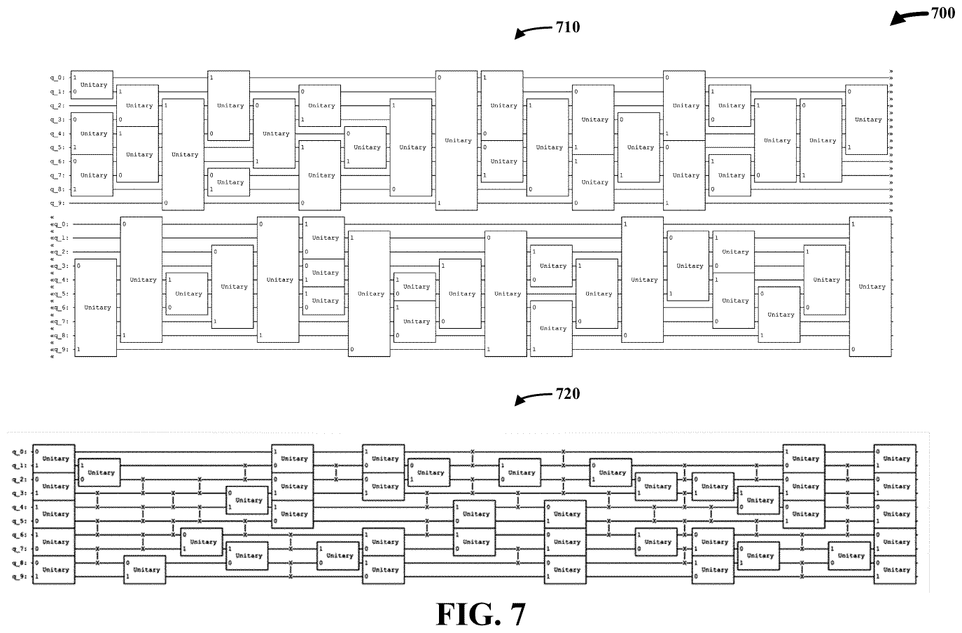

FIG. 7 depicts an example output 700 of transpiling a quantum circuit using the reinforcement learning method described herein, in accordance with one or more embodiments. Repetitive description of like elements employed in other embodiments described herein is omitted for sake of brevity.

Example output 700 includes example input quantum circuit representation 710 and example transpiled quantum circuit representation 720. In this example, by decreasing the number of gates utilized, the transpiled quantum circuit can be performed in less time that the input quantum circuit, and on less powerful quantum hardware, thereby improving performance of a quantum computing system utilized to execute the quantum circuits and reducing the hardware requirements of quantum hardware.

Quantum circuit transpiling system 102 can provide technical improvements to a processing unit associated with quantum circuit transpiling system 102. For example, by utilizing reinforcement learning, quantum circuit are transpiled faster, thereby reducing the workload of a processing unit (e.g., processor 106) that is employed to execute routines (e.g., instructions and/or processing threads) involved in transpiling quantum circuits. In this example, by reducing the workload of such a processing unit (e.g., processor 106), quantum circuit transpiling system 102 can thereby facilitate improved performance, improved efficiency, and/or reduced computational cost associated with such a processing unit. Further, by utilizing a reinforcement learning model, instead of a large search database and search algorithms, the amount of memory storage utilized by quantum circuit transpiling system 102 is reduced, thereby reducing the workload of a memory unit (e.g., memory 108) associated with quantum circuit transpiling system 102. Quantum circuit transpiling system 102 can thereby facilitate improved performance, improved efficiency, and/or reduced computational cost associated with such a memory unit.

A practical application of quantum circuit transpiling system 102 is that it allows for transpiling of quantum circuits utilizing a reduced amount of computing and/or network resources, in comparison to other methods. For example, databases of quantum circuits can utilize up to 2 TB of storage, thereby utilizing large memory requirements, which limits the types of computer systems capable of performing quantum circuit transpiling. Furthermore, as the number of possible quantum circuits grows in relation to the number of qubits for a quantum system, the storage requirements of quantum circuit databases serve as a limit to the number qubits in quantum systems. By eliminating the requirement for quantum circuit databases, quantum circuit transpiling system 102 can enable transpiling of quantum circuits for quantum systems with greater numbers of qubits. Quantum circuit transpiling system 102 can additionally produce circuits with a reduced number of gates, number of layers, number of CNOT gates, a number of layers with CNOTs in comparison to various other approaches. Therefore, quantum circuit transpiling system 102 can enable transpiled quantum circuits that can be operated with reduced quantum hardware requirements, thus promoting scalability of quantum systems. Furthermore, by reducing the number of gates within generated quantum circuits while maintaining circuit accuracy, execution time of the quantum circuits is thereby reduced, improving performance of quantum simulators and/or quantum computers utilized in executing the quantum circuits.

It is to be appreciated that quantum circuit transpiling system 102 can utilize various combination of electrical components, mechanical components, and circuitry that cannot be replicated in the mind of a human or performed by a human as the various operations that can be executed by quantum circuit transpiling system 102 and/or components thereof as described herein are operations that are greater than the capability of a human mind. For instance, the amount of data processed, the speed of processing such data, or the types of data processed by quantum circuit transpiling system 102 over a certain period of time can be greater, faster, or different than the amount, speed, or data type that can be processed by a human mind over the same period of time. According to several embodiments, quantum circuit transpiling system 102 can also be fully operational towards performing one or more other functions (e.g., fully powered on, fully executed, and/or another function) while also performing the various operations described herein. It should be appreciated that such simultaneous multi-operational execution is beyond the capability of a human mind. It should be appreciated that quantum circuit transpiling system 102 can include information that is impossible to obtain manually by an entity, such as a human user. For example, the type, amount, and/or variety of information included in quantum circuit transpiling system 102 can be more complex than information obtained manually by an entity, such as a human user.

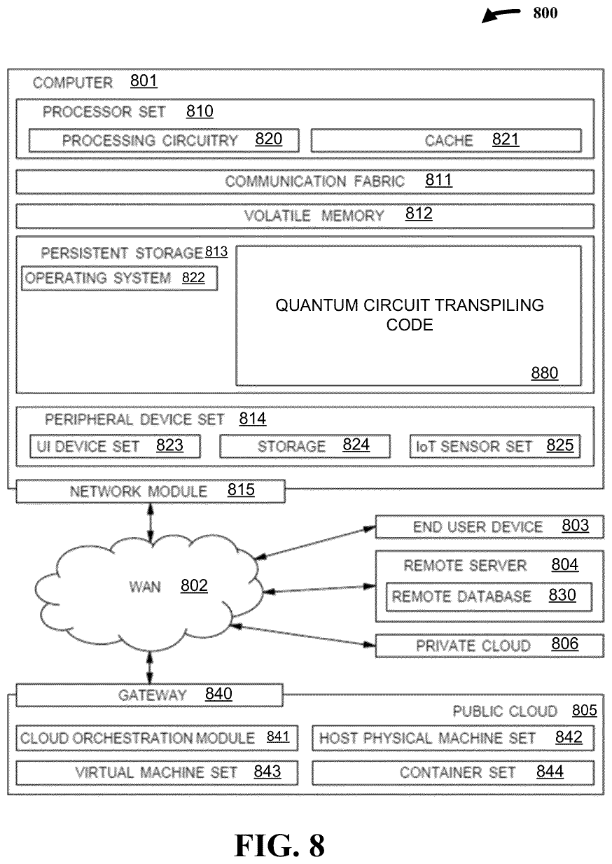

FIG. 8 and the following discussion are intended to provide a brief, general description of a suitable computing environment 800 in which one or more embodiments described herein at FIGS. 1-6 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code involved in performing the inventive methods, such as translation of an original source code based on a configuration of a target system by the quantum circuit transpiling code 880. In addition to block 880, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 880, as identified above), peripheral device set 814 (including user interface (UI), device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 830. As is well understood in the art of computer technology, and depending upon the technology, performance of a computer-implemented method can be distributed among multiple computers and/or between multiple locations. On the other hand, in this presentation of computing environment 800, detailed discussion is focused on a single computer, specifically computer 801, to keep the presentation as simple as possible. Computer 801 can be located in a cloud, even though it is not shown in a cloud in FIG. 8. On the other hand, computer 801 is not required to be in a cloud except to any extent as can be affirmatively indicated.

PROCESSOR SET 810 includes one, or more, computer processors of any type now known or to be developed in the future. Processing circuitry 820 can be distributed over multiple packages, for example, multiple, coordinated integrated circuit chips. Processing circuitry 820 can implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set can be located “off chip.” In some computing environments, processor set 810 can be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods can be stored in block 880 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 812 is any type of volatile memory now known or to be developed in the future. Examples include dynamic type random access memory (RAM) or static type RAM. Typically, the volatile memory is characterized by random access, but this is not required unless affirmatively indicated. In computer 801, the volatile memory 812 is located in a single package and is internal to computer 801, but, alternatively or additionally, the volatile memory can be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 can be a read only memory (ROM), but typically at least a portion of the persistent storage allows writing of data, deletion of data and rewriting of data. Some familiar forms of persistent storage include magnetic disks and solid-state storage devices. Operating system 822 can take several forms, such as various known proprietary operating systems or open-source Portable Operating System Interface type operating systems that employ a kernel. The code included in block 880 typically includes at least some of the computer code involved in performing the inventive methods.

PERIPHERAL DEVICE SET 814 includes the set of peripheral devices of computer 801. Data communication connections between the peripheral devices and the other components of computer 801 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 823 can include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 can be persistent and/or volatile. In some embodiments, storage 824 can take the form of a quantum computing storage device for storing data in the form of qubits. In embodiments where computer 801 is required to have a large amount of storage (for example, where computer 801 locally stores and manages a large database) then this storage can be provided by peripheral storage devices designed for storing large amounts of data, such as a storage area network (SAN) that is shared by multiple, geographically distributed computers. IoT sensor set 825 is made up of sensors that can be used in Internet of Things applications. For example, one sensor can be a thermometer and another sensor can be a motion detector.

NETWORK MODULE 815 is the collection of computer software, hardware, and firmware that allows computer 801 to communicate with other computers through WAN 802. Network module 815 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801) and can take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 can be a client device, such as thin client, heavy client, mainframe computer and/or desktop computer.

REMOTE SERVER 804 is any computer system that serves at least some data and/or functionality to computer 801. Remote server 804 can be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data can be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs can be stored as images and can be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware and firmware allowing public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system comprising:
a memory that stores computer executable components;
a processor that executes the computer executable components stored in the memory, wherein the computer executable components comprise:
a receiver component that receives an input quantum circuit representation and one or more quantum circuit constraints; and
a machine learning component that generates a transpiled quantum circuit representation based on the one or more quantum circuit constraints and the input quantum circuit representation.

2. The system of claim 1, wherein the generating the transpiled quantum circuit representation comprises:
selecting one or more gate options from a plurality of gate options;
assigning a penalty term to the selected one or more gate options based on the one or more quantum circuit constraints; and
selecting one or more additional gate options from the plurality of gate options based on the penalty term.

3. The system of claim 2, wherein the plurality of gate options comprise a SWAP option to add a SWAP layer to the transpiled quantum circuit representation during generation of the transpiled quantum circuit representation.

4. The system of claim 3, wherein selection the one or more additional gate options is further based on gates of the input quantum circuit representation remaining to be transpiled.

5. The system of claim 1, wherein the transpiled quantum circuit representation is generated further based on a defined preference and a target quantum computer.

6. The system of claim 5, wherein the defined preference comprises one or more performance characteristics of the target quantum computer, wherein the one or more performance characteristics are selected from a group consisting of:
performance gates of the target quantum computer,
a coupling map of qubits of the target quantum computer,
a gate canceling optimization of the target quantum computer, and
a gate merging optimization of the target quantum computer.

7. The system of claim 5, wherein the one or more quantum circuit constraints comprise descriptive characteristics of the target quantum computer, wherein the descriptive characteristics of the target quantum computer are selected from a group consisting of:
a number of qubits comprised in the target quantum computer,
basis gates of the target quantum computer,
a time step parameter for gate operations of the target quantum computer,
measurement levels the target quantum computer, and
a measurement map of qubits of the target quantum computer.

8. The system of claim 5, wherein the defined preference comprises one or more characteristics of a configuration of the target quantum computer, wherein the one or more characteristics of the configuration of the target quantum computer are selected from a group consisting of:
an estimated resonance frequency of qubits of the target quantum computer,
an estimated frequency of state measurement pulses of the target quantum computer,
a buffer time required between successive operations on the target quantum computer,
a pulse library of the target quantum computer,
a set of available quantum operations of the target quantum computer,
an algorithm that processes qubit measurements to produce usable data from the target quantum computer,
a discriminator of the target quantum computer, and
a data structure that stores results of quantum operations of the target quantum computer.

9. The system of claim 5, wherein the generating the transpiled quantum circuit representation comprises:
generating a plurality of candidate quantum circuit representations based on the input quantum circuit representation; and
selecting the transpiled quantum circuit representation from the plurality of candidate quantum circuit representations based on the defined preference.

10. The system of claim 5, wherein the defined preference is selected from a group consisting of: a controlled not (CNOT) gates, a number of circuit layers with CNOT gates, length of the quantum circuit, and estimated total gate noise of the quantum circuit.

11. The system of claim 1, wherein the computer executable components further comprise:
a performance component that identifies a performance metric representing a difference between the input quantum circuit representation and the transpiled quantum circuit representation; and
a training component that retrains the machine learning component based on maximizing the performance metric and the transpiled quantum circuit representation.

12. The system of claim 1, wherein the machine learning component comprises a reinforcement learning model.

13. The system of claim 1, wherein the input quantum circuit representation comprises a quantum circuit represented as a series of gates.

14. A computer program product, the computer program product comprising a computer readable storage medium having program instructions embodied therewith, the program instructions executable by a processor to cause the processor to:
receive an input quantum circuit representation and one or more quantum circuit constraints; and
generate a transpiled quantum circuit representation based on the one or more quantum circuit constraints and the input quantum circuit representation.

15. The computer program product of claim 14, wherein the generating the transpiled quantum circuit representation comprises:
selecting one or more gate options from a plurality of gate options;
assigning a penalty term to the selected one or more gate options based on the one or more quantum circuit constraints; and
selecting one or more additional gate options from the plurality of gate options based on the penalty term.

16. The computer program product of claim 14, wherein the transpiled quantum circuit representation is generated further based on a defined preference, comprising performance characteristics of a target quantum computer, wherein the performance characteristics are selected from a group consisting of:
performance gates of the target quantum computer,
a coupling map of qubits of the target quantum computer,
a gate canceling optimization of the target quantum computer, and
a gate merging optimization of the target quantum computer.

17. The computer program product of claim 14, wherein the one or more quantum circuit constraints comprise descriptive characteristics of a target quantum computer, wherein the descriptive characteristics of the target quantum computer are selected from a group consisting of:
a number of qubits comprised in the target quantum computer,
basis gates of the target quantum computer,
a time step parameter for gate operations of the target quantum computer,
measurement levels the target quantum computer, and
a measurement map of qubits of the target quantum computer.

18. A computer-implemented method comprising:
receiving, by a system operatively coupled to a processor, an input quantum circuit representation and one or more quantum circuit constraints; and
generating, by the system, using a machine learning model, a transpiled quantum circuit representation based on the one or more quantum circuit constraints and the input quantum circuit representation.

19. The computer-implemented method of claim 18, further comprising:
determining, by the system, a performance metric representing a difference between the input quantum circuit representation and the transpiled quantum circuit representation; and
retraining, by the system, the machine learning model based on maximizing the performance metric and the transpiled quantum circuit representation.

20. The computer-implemented method of claim 18, wherein the machine learning model comprises a reinforcement learning model.
